(19) United States
(12) Patent Application Publication
(10) Pub. No.: US 2017/0053482 A1
(43) Pub. Date: Feb. 23, 2017

(54) HINGE DEVICE FOR LIFTING A PANEL OF A GAME MACHINE

(71) Applicant: ENTROPY PRECISION SYSTEM INC., Taipei City (TW)

(72) Inventor: SHIH-AN HO, Taipei City (TW)

(21) Appl. No.: 14/964,118

(22) Filed: Dec. 9, 2015

(30) Foreign Application Priority Data
Aug. 17, 2015 (TW) 104213258

(51) Int. Cl. G07F 17/32

(52) U.S. Cl. CPC G07F 17/3216

(57) ABSTRACT

A hinge device for lifting a panel of a game machine is provided between the main body and the panel of the game machine to lift the panel away from the main body. The hinge device comprises a rotation shaft and at least one telescopic connecting rod. The rotation shaft has a receiving space and two ends respectively pivotally connected to the main body's interior and the panel at a position adjacent to the panel's top. Each connecting rod has two ends respectively pivotally connected into the interior of the main body and to the panel at a position where the panel faces the main body's interior. The connecting rod is upward stretched out to lift the panel, so that the panel's top is moved into the receiving space of the rotation shaft and thus par of the panel is received in the main body's interior.

### TECHNICAL FIELD

The present invention relates to a hinge device for lifting a panel of a game machine, and the hinge device is structurally simple and convenient for repair and maintenance.

### BACKGROUND

In modern society, due to the intense competition at work, people suffer much more stress than before. In order to maintain the mental and physical balance, various kinds of recreational activities are developed, such as physical exercises, fishing, painting, and movie-watching. Among various kinds of recreational activities, playing games by using “game machines” could directly generate physical and sensory stimuli for players to have themselves relieved and provide the players with sense of satisfaction through material or spiritual rewards. Thereby, for most people playing games by using game machines are their chief recreational activities.

According to the conventional game machines' structure design, after the processing performed by the design of complicated circuits, images can be shown on the display of panels to interact with the players. When the routine maintenance or repair is to be undertaken, it would be required to open the panels in order to inspect the components or circuits underneath the panel. However, the connection structure between the panel and the main body of a conventional game machine makes it difficult for the workers to carry out the maintenance or repair, which would be limited by some factors such as the confined space or workers' physical statute. Particularly, during the process of maintenance or repair, relatively larger space is required for the maintenance and repair in order to lift the panel of the game machine. Besides, limited by the swing range of the workers' arms, it would be difficult for them to handle the components in the deeper part inside the main body of the game machine. Moreover, during the process of maintenance or repair, the workers would be required to crouch or bend low in order to get access to the deeper part inside the main body of the game machine, which would further hinders their operation. Therefore, it is obviously inconvenient and time-consuming for workers to carry out the maintenance or repair for such a conventional game machine.

### SUMMARY OF THE DISCLOSURE

An object of the present invention is to provide a hinge device for lifting a panel of a game machine, and the hinge device is structurally simple and convenient for repair and maintenance.

In order to achieve above object, the present invention provides a hinge device for lifting a game machine panel. The hinge device is provided between a main body and a panel of a game machine to lift the panel away from the main body. The hinge device is characterized in that it comprises a rotation shaft and at least one connecting rod. The rotation shaft has one end pivotally connected to the interior of the main body and the other end pivotally connected to the panel at a position adjacent to the top of the panel. Besides, the rotation shaft has a receiving space. Each of the at least one telescopic connecting rod has one end pivotally connected into the interior of the main body and the other end pivotally connected to the panel at a position where the panel faces the interior of the main body, so that the connecting rod is able to be upward stretched out to lift and support the panel until the panel is fully lifted. When the panel is lifted, the top of the panel is located into the receiving space of the rotation shaft so that part of the panel is received in the interior of the main body.

In implementation, the rotation shaft is a C-shaped rotation shaft, and the C-shaped rotation shaft has a curved surface that forms the receiving space.

In implementation, at least one support rod is provided between the rotation shaft and the at lease one connecting rod, and each support rod has two ends one of which is pivotally connected into the interior of the main body while the other of which is pivotally connected to the panel.

The following detailed description, given by way of examples or embodiments, will best be understood in conjunction with the accompanying drawings.

### BRIEF DESCRIPTION OF THE DRAWINGS

FIG. 1 is a perspective view showing a game machine in an embodiment according to the present invention.

FIG. 2 is a schematic view showing the combination of a panel and a hinge device in the embodiment according to the present invention.

FIG. 3 is a lateral view showing the combination of the panel and the hinge device in the embodiment according to the present invention.

FIG. 4 is a schematic view showing that the panel in the embodiment according to the present invention is being lifted.

FIG. 5 is a schematic view showing that the panel in the embodiment according to the present invention is fully lifted.

FIG. 6 is a perspective view showing the game machine with the fully lifted panel in the embodiment according to the present invention.

### DETAILED DESCRIPTION

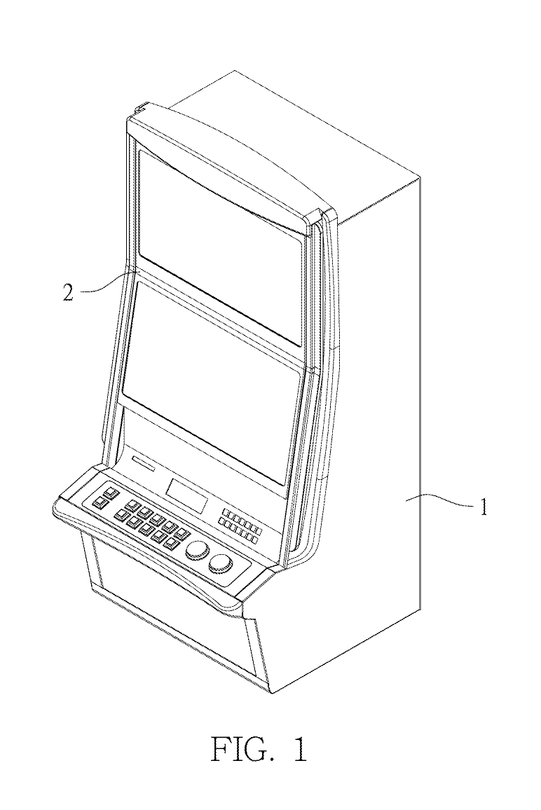

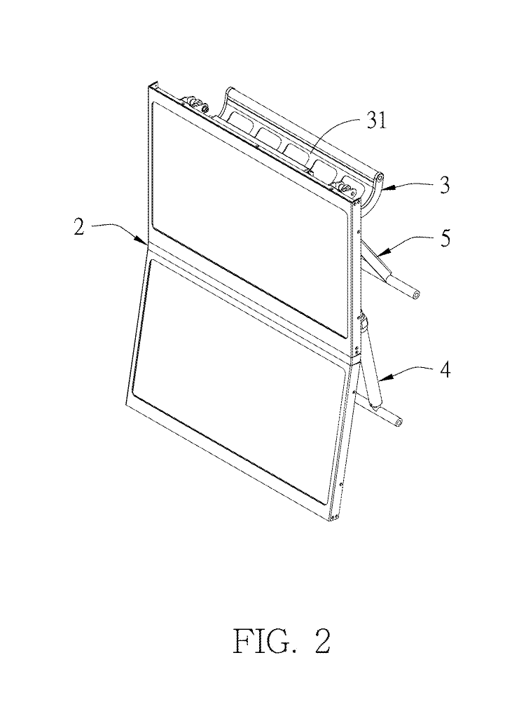

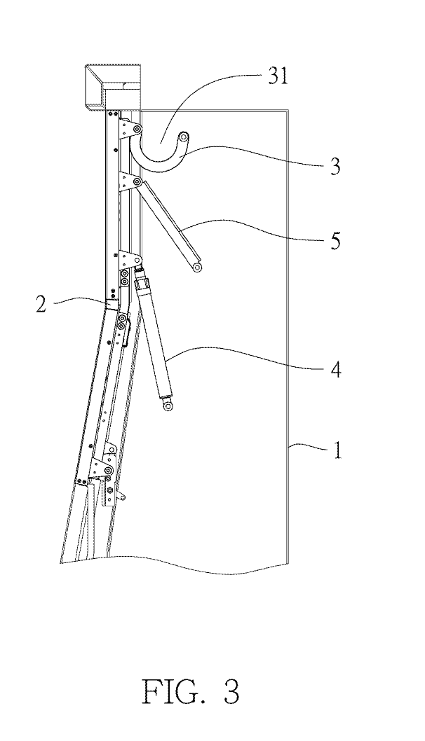

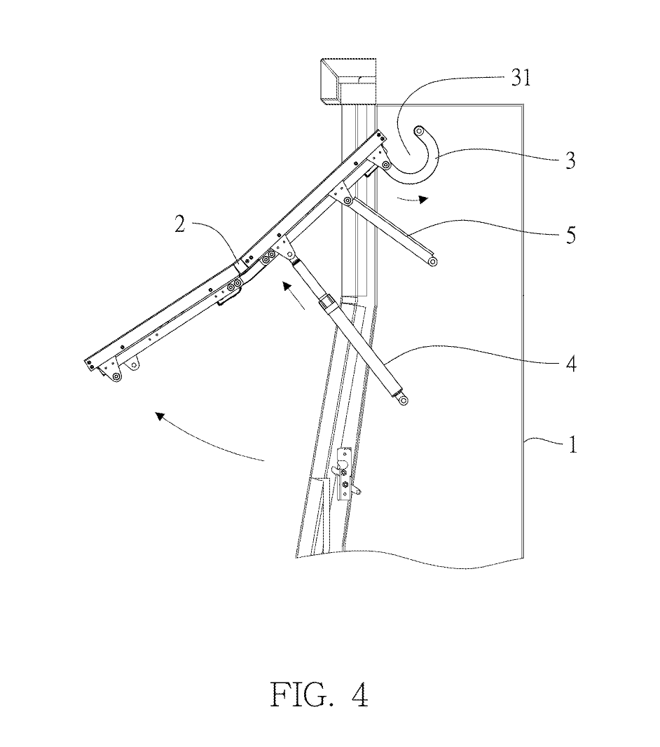

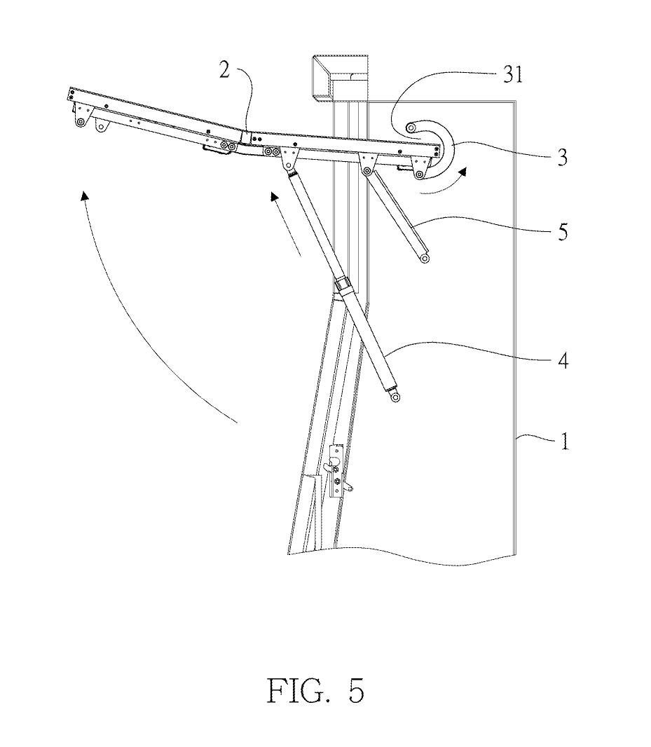

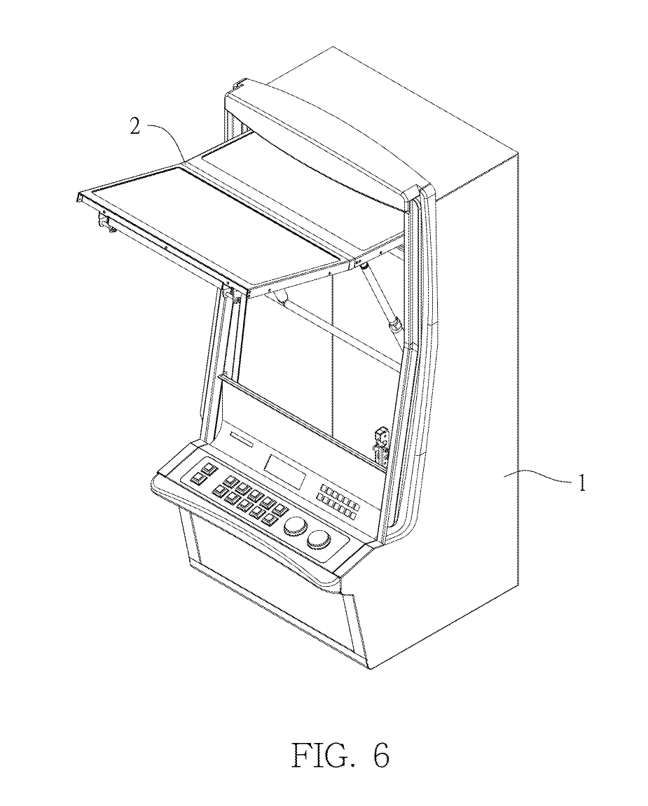

Please refer to FIGS. 1-6 showing an embodiment of a hinge device for lifting the panel of a game machine. The hinge device is provided between a main body 1 and a panel 2 of the game machine, so as to lift the panel 2 away from the main body 1. The hinge device comprises a rotation shaft 3 and at least one telescopic connecting rod 4.

The rotation shaft 3 has one end pivotally connected into the interior of the main body 1 and the other end pivotally connected to the panel 2 at a position adjacent to the top of the panel 2. The rotation shaft has a receiving space 31. In implementation, the rotation shaft 3 can be a C-shape rotation shaft having a curved surface forming the receiving space 31. The rotation shaft 3 also can be in other shapes such as U-shape or L-shape capable of forming the receiving space 31.

Each telescopic connecting rod 4 has one end pivotally connected into the interior of the main body 1 and the other end pivotally connected to the panel 2 at a position where the panel facing the interior of the main body 1. Accordingly, when the panel 2 is lifted, the connecting rod 4 could be upward stretched out to support the panel 2 until the panel 2 is fully lifted. In implementation, the telescopic connecting rod 4 can be stretched out by means of mechanical mechanism (such as springs or snaps) or pneumatic mechanism (such as pneumatic cylinders). By means of these mechanisms, the telescopic connecting rod can be driven to be upward stretched out to lift the panel 2. In other words, during the lifting of the panel 2, the connecting rod 4 is stretched out in the same direction with the movement of the panel 2. When the connecting rod 4 is driven to be withdrawn downward, the panel 2 is moved with the connecting rod 4 back onto the main body 1.

Moreover, at least one support rod 5 is provided between the rotation shaft 3 and the connecting rod 4. Each support rod 5 has one end pivotally connected into the interior of the main body 1 and the other end pivotally connected to the panel 2.

When it is required to undertake the repair or maintenance for a game machine, during the upward lifting of the panel 2 of the game machine, the top of the panel 2 is gradually moved into the receiving space 31 of the rotation shaft, so that part of the panel 2 is gradually received into the interior of the main body 1. Thereby, when the panel 2 is fully lifted, because part of the panel 2 is received into the interior of the main body 1, it would be convenient to undertake the repair or maintenance for the components inside the main body of the game machine more quickly without the need of overstretching their arms. Moreover, less space is required to locate the game machine especially after its panel is fully lifted.

Therefore, by means of the hinge device according to the present invention, the space left unused in the main body 1 can be used to receive part of the panel 2 after the panel 2 is lifted.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

As disclosed in the above description and attached drawings, the present invention achieves the object and provides a hinge device for lifting game machine panels. It is new and can be put into industrial use.

What is claimed is:

1. A hinge device for lifting a panel of a game machine, provided between a main body and a panel of the game machine to lift the panel away from the main body; the hinge device being characterized in that it comprises:
a rotation shaft, having one end pivotally connected to the main body's interior and the other end pivotally connected to the panel at a position adjacent to a top of the panel, and having a receiving space; and
at least one telescopic connecting rod, each of which has one end pivotally connected into the interior of the main body and the other end pivotally connected to the panel at a position where the panel faces the interior of the main body, so that the connecting rod is able to be upward stretched out to lift and support the panel until the panel is fully lifted, and when the panel is lifted, the top of the panel is located into the receiving space of the rotation shaft, so that part of the panel is received in the interior of the main body.

2. The hinge device for lifting a panel of a game machine as claimed in claim 1, wherein the rotation shaft is a C-shaped rotation shaft, and the C-shaped rotation shaft has a curved surface that forms the receiving space.

3. The hinge device for lifting a panel of a game machine as claimed in claim 1, wherein at least one support rod is provided between the rotation shaft and the at lease one connecting rod, and each support rod has one end pivotally connected into the interior of the main body and the other end pivotally connected to the panel.
